(19) United States
(12) Patent Application Publication
(10) Pub. No.: US 2010/0162940 A1
(43) Pub. Date: Jul. 1, 2010

(54) Blue Dot Moisture Detector

(76) Inventors: Stephen A. Hill, Brisbane, CA (US); Eric R. Hill, Brisbane, CA (US)

Correspondence Address: Stephen A. Hill, 462 Alvarado Street, Brisbane, CA, 94005, US

(21) Appl. No.: 12/346,560

(22) Filed: Dec. 30, 2008

(51) Int. Cl. G01N 21/81

(52) U.S. Cl. 116/206

(57) ABSTRACT

A ‘Blue Dot’ stick-on moisture indicator system that includes a stick-on transparent, polypropylene film patch with a sticky, pressure sensitive, hot melt, rubber-resin that applies on one surface, a dimensionally smaller, ‘Blue Dot’ indicator patch and a dimensionally larger, silicon treated, release (peel) liner strip to which a plurality of stick-on film patches with ‘Blue Dot’ indicator patches, are affixed to such that functionally isolates both the moisture sensitive ‘Blue Dot’ (cobalt chloride treated paper) from moisture and the surrounding sticky surface of the stick-on film from debris before the indicator is applied or deployed (adhered) onto a surface.

### FIELD OF THE INVENTION

This invention relates to a moisture detector system and more particularly, to an adhesive moisture detector system, which utilizes a polypropylene film patch in combination with a moisture sensitive Blue Dot (cobalt chloride treated paper) which is attached to the subject surface.

### BACKGROUND OF THE INVENTION

Within many areas of a residential or commercial building it is desirable to know whether the building, particular rooms or spaces have been exposed to a particular level of humidity which could cause damage to the construction or contents of those rooms or spaces. For example, cabinets, ceilings, floors, woodwork, drywall, electronic components, etc. can be damaged by exposure to high levels of humidity, even where the exposure is only for short periods of time.

To address the need for the detection of humidity levels within residential or commercial buildings humidity indicators have been developed. There are generally two types of humidity indicators. One of these humidity indicators reversibly changes color upon exposure to particular humidity levels. Such reversible humidity indicators typically utilize cobalt chloride as the humidity indicator material. It changes color when exposed to predetermined levels of humidity and returns to its original color when the humidity level drops below that predetermined level. These reversible humidity indicators are used to indicate the current condition of a desiccant and/or the current humidity level within a given space.

The second type of humidity indicator is an irreversible humidity indicator. These indicators are designed to detect a predetermined level of humidity and provide a visual indication of whether components stored in the containers where these humidity indicators are used have been exposed to that predetermined level of humidity even for short periods of time and even if the level of humidity drops below that predetermined level when the components are checked at a later time. Large changes in humidity levels sometimes occur where storage containers are used in relatively warm climates where the moisture level in the air rises and falls dramatically depending upon the temperature of the surrounding air. Under these conditions, a reversible humidity indicator might fail to indicate the temporary presence of high humidity within a storage container even though such high humidity may be sufficient to cause damage to the components present in the storage container.

One of the first irreversible humidity indicator devices was disclosed in U.S. Pat. No. 2,214,354, which disclosed the use of a calcium chloride material which was mixed with a water soluble dye and deposited on a porous surface material, such as a sheet of absorbent paper. Upon exposure of the absorbent sheet to a predetermined humidity level, the calcium chloride material liquifies and releases the dye in liquid form. The dye is then carried by capillary action onto the porous surface of the absorbent paper, where it produces a permanent and irreversible dye mark. The aforementioned patent further describes various deliquescent agents which may be employed to show different humidity levels.

To maintain a consistently acceptable humidity level, many homes depend upon the combination of air conditioning and heating depending upon the climatic conditions. This does not address the acute, potentially damaging problems caused by leaking plumbing, groundwater intrusion, rainwater intrusion, etc. Some homeowners utilize desiccant materials. These desiccant materials dehydrate a given space or area and are intended to maintain the humidity level within that area at an acceptable level.

These desiccant materials guard against but do not guarantee that damaging levels of humidity will not occur, nor do they provide sufficient indication that damaging levels of humidity are present. In order to determine whether the humidity level in these areas have reached certain critical levels, moisture indicators can be placed within these areas with the desiccant materials. These moisture indicators can be reviewed at the same time that the desiccant material is being checked to determine whether a harmful humidity level has been reached in the area.

A series of relative humidity indicators, each utilizing a different deliquescent salt, are disclosed in a series of patents which were issued during the 1940's and 1950's including U.S. Pat. Nos. 2,460,065, 2,460,066, 2,460,067, 2,460,068, 2,460,069, 2,460,070, 2,460,071, 2,460,072, 2,460,073, 2,460,074, 2,526,938, 2,580,737, and 2,627,505. In addition, some humidity indicator cards are capable of showing different levels of humidity on the same card by use of a series of different deliquescent agents that change color at varying humidity levels, as disclosed in U.S. Pat. No. 2,249,867.

Humidity indicator sheets and cards which contain deliquescent salts and dyes have commonly been used to detect the relative humidity level present within storage containers. See for example, U.S. Pat. Nos. 2,249,867, 4,034,609, 4,150,570, and 4,854,160. Button-type humidity indicators or “plug” humidity indicators are also sometimes used with packaging material and are disclosed, for example, by U.S. Pat. Nos. 2,716,338, 3,084,658 and 4,050,307. Another device for monitoring humidity levels, particularly in poured cement, is disclosed in U.S. Pat. No. 3,680,364.

A multiple layer, reversible humidity sensing device containing a reflective layer, which is useful in viewing the changes in color of a humidity indicator card is disclosed by U.S. Pat. No. 4,034,609.

A reversible humidity indicator card contained within transparent, flexible sheet materials with an impermeable front layer is disclosed in U.S. Pat. No. 5,224,373. This humidity indicator card is specifically designed for utilization with electronic components. It is formed as a “window” in a barrier bag.

A delayed action, irreversible humidity indicator card is disclosed in U.S. Pat. No. 4,793,180.

All irreversible humidity indicator cards known hitherto are based on combinations of deliquescent salts and water-soluble dyes. In order to prepare humidity indicator cards that react at various humidity levels, different combinations of deliquescent salts and dyes must be chosen. Only cards that show the same change in color at each chosen humidity level are acceptable to users of these cards. Otherwise, if there are varying color changes, it may be difficult to determine whether a particular humidity level has been reached. W. B. Abel: Chemical Maximum Humidity Indicator Update Report, BDX-613-1989 and U.S. Pat. No. 3,898,172 teach that only certain combinations of salts and dyes are useful for this purpose as the dye is quite soluble in the saturated salt solution that is formed upon deliquescence. In addition, the solubility and color of the dye must be independent of pH changes that may be attributed to the deliquescence of the salt. To ensure a proper shelf-life of the indicator card, the dye also must not react with the salt in any way (e.g. redox reaction, acid-base reaction). It is quite difficult to use either the same dye or different dyes with the same color and different salts over the entire humidity spectrum.

Mixing the individual salts with the dye is an additional required step for the production of the irreversible humidity indicators previously known. If the chosen salt and dye have different particle sizes, inhomogeneous distribution of the dye in the salt may occur and lead to inhomogeneous color and appearance on the indicating spot of the humidity indicator. This problem can be overcome by milling salt and dye together, but this is not possible for all salt-dye combinations, especially if the salt already holds water of crystallization.

Further, many of the deliquescent salts when they absorb moisture and melt can cause corrosion to the products stored in the shipping containers in which the humidity indicator cards are utilized.

In addition, the blotter paper used to form conventional humidity indicator cards sometimes sheds paper fibers and lint. Such fibers and lint may damage products that are sensitive to dust, such as electronic components.

### SUMMARY OF THE INVENTION

This is a ‘Blue Dot’ stick-on moisture detector system that includes a stick-on transparent, polypropylene film patch with a sticky, pressure sensitive, hot melt, rubber-resin that applies on one surface, a dimensionally smaller, ‘Blue Dot’ detector patch and a dimensionally larger, silicon treated, release (peel) liner strip to which a plurality of stick-on film patches with ‘Blue Dot’ detector patches, are affixed to such that functionally isolates both the moisture sensitive ‘Blue Dot’ (cobalt chloride treated paper) from moisture and the surrounding sticky surface of the stick-on film from debris before the indicator is applied or deployed (adhered) onto a surface.

Our invention indicates moisture intrusion into unseen areas. When the Blue Dot moisture detector is applied according to directions, the blue dot will change color to pink when moisture is present. This early warning lets a homeowner know there is potential moisture related problem in time to take corrective measures before the moisture becomes more widespread and visible causing significant problems such as mold, stains, structurally compromised walls, etc. This invention provides a homeowner an inexpensive, easy to use non-mechanical device that will monitor unseen moisture intrusion into walls of a building, cabinets, floors, ceilings, etc. Once applied to a wall, ceiling, cabinet interior, etc, the Blue Dot detectors only need to be visually monitored for color changes. Early detection of moisture intrusion leads to early correction of problems with the savings potential of thousands of dollars often needed for extensive repairs.

### BRIEF DESCRIPTION OF THE DRAWINGS

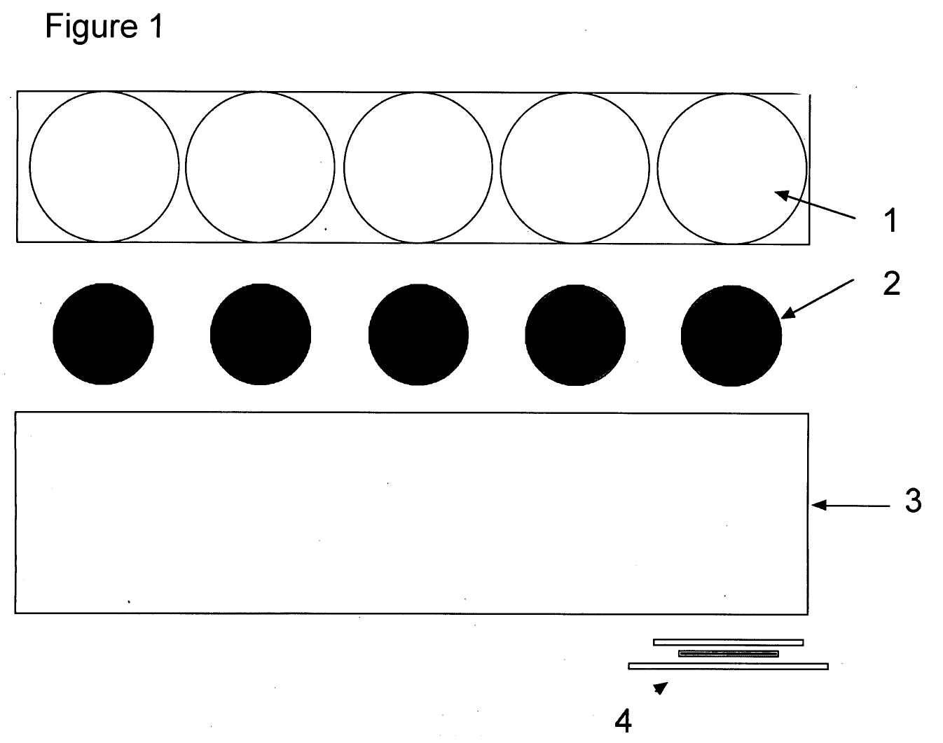

FIG. 1 Side view of Blue Dot Moisture Detector showing:
Top layer—Clear adhesive backed film
Middle layer—Blue Dot reactive paper
Bottom layer—Silicon treated release liner

### DESCRIPTION OF THE PREFERRED EMBODIMENT

FIG. 1 (1) Clear polypropylene film with a pressure sensitive hot melt rubber-resin applied
to the bottom side of the 1½″ diameter circle.
   The clear film provides a window through which the Blue Dot color changes are easily visible. The adhesive holds the reactive paper and clear film window in place and provides the means by which the reactive paper Blue Dot is attached to the area to be tested. In addition, the clear film provides a barrier to overall room humidity readings and other external contamination.

(2) The reactive (cobalt chloride impregnated) 1″ paper circle adheres to the center
of the adhesive side of the clear film, leaving a ¼″ border of the adhesive backed
larger film circle to attach to the area being tested.
   When removed from the backing sheet (3) and applied securely to the test area, the reactive “Blue Dot” impregnated paper will gradually change from blue to pink if there is moisture inside the wall. If there is no immediate color change, the Blue Dot can be left in place for up to 6 months to monitor the area. The adhesive backed clear film border holds the Blue Dot portion of the moisture detector securely against the area being tested, while providing a barrier to overall room humidity readings.

(3) The silicon treated release liner protects both the Blue Dot and the adhesive backed clear film border from contamination until ready to use.
The release liner holds the moisture detectors until they are needed. The moisture detectors are simply peeled off the backing, placed in position and rubbed gently, to ensure an air tight seal between the Blue Dot and the test area.

4. Side view of Blue Dot Moisture Detector showing:
Top layer—Clear adhesive backed film
Middle layer—Blue Dot reactive paper
Bottom layer—Silicon treated release liner

We claim:

1. A blue dot moisture detector comprising in combination;
a) an adhesive backed polypropylene disk;
b) a dimensionally smaller blue dot patch of cobalt chloride treated paper.

2. A blue dot moisture detector system in accordance to claim 1 wherein; the device is of a non-mechanical nature.

3. A blue dot moisture detector system in accordance to claim 1 wherein; the device changes color to indicate moisture level.

4. A blue dot moisture detector system in accordance to claim 1 wherein; the device does not require tools or power for function.

5. A blue dot moisture detector system in accordance to claim 1 wherein; the device can be easily disposed of after use.

6. A blue dot moisture detector system in accordance to claim 1 wherein; the device has an easy peel liner.
